(19) United States
(12) Patent Application Publication
(10) Pub. No.: US 2026/0148160 A1
(43) Pub. Date: May 28, 2026

(54) ADAPTIVE WORKFLOW ORCHESTRATION USING NEUROPHYSIOLOGICAL DATA IN ENTERPRISE RESOURCE PLANNING SYSTEMS

(71) Applicant: Sudheer Devaraju, Aubrey, TX (US)

(72) Inventor: Sudheer Devaraju, Aubrey, TX (US)

(21) Appl. No.: 18/957,668

(22) Filed: Nov. 23, 2024

(51) Int. Cl. G06Q 10/0631; G06F 3/01; G06N 3/02; G06Q 10/0639

(52) U.S. Cl. CPC G06Q 10/06316; G06F 3/015; G06N 3/02; G06Q 10/06398

(57) ABSTRACT

The invention relates to a system and method for optimizing task assignments in an enterprise environment using real-time biometric data collected from wearable devices. The system comprises a wearable device for capturing biometric signals such as heart rate, EEG data, and other physiological metrics, a data processor to filter and validate the data, a cognitive analyzer to calculate cognitive metrics including cognitive load, stress levels, and focus, and a workflow optimizer to assign tasks based on these metrics. The workflow optimizer leverages machine learning algorithms to analyze the cognitive state of users, compare it with historical performance data, and adjust workload distribution dynamically. The system integrates with enterprise resource planning (ERP) systems to synchronize optimized task assignments across the organization. By monitoring cognitive metrics in real time, the invention ensures efficient workload management, reduces employee fatigue, and enhances overall productivity.

### FIELD OF THE INVENTION

The present invention relates to enterprise resource management systems and workflow optimization techniques. More specifically, it pertains to systems and methods for dynamic task assignment and resource allocation in enterprise environments using real-time neurophysiological data collected from wearable devices. The invention integrates wearable technology, biometric data processing, and enterprise task management systems to enhance employee productivity, optimize resource utilization, and improve overall workplace well-being.

### BACKGROUND OF THE INVENTION

In modern enterprises, effective task and workflow management is critical for maximizing productivity and maintaining a competitive edge. However, traditional approaches to workflow management often rely on static task assignments and predetermined performance metrics, which fail to account for the dynamic nature of employee performance. Cognitive and physiological states, influenced by factors such as stress, workload, and mental fatigue, play a significant role in determining individual productivity. Ignoring these factors can lead to inefficiencies, decreased performance, and employee burnout.

The advent of wearable technology, such as smartwatches and fitness trackers, has introduced new possibilities for real-time monitoring of an individual's physiological and cognitive states. These devices, equipped with sensors for tracking heart rate, movement, and other biometrics, provide valuable insights into stress levels, cognitive load, and overall well-being. Despite their widespread use in personal health monitoring, the potential of these wearables for enterprise applications remains largely untapped.

At the same time, enterprises increasingly rely on complex task and workflow management systems, such as ticketing systems and resource planning platforms, to allocate work across teams. These systems are typically designed to assign tasks based on static rules or historical performance data without considering the real-time state of the employee. As a result, they fail to optimize task allocation dynamically, especially in high-stress environments like customer service centers, IT support teams, or project management offices.

Furthermore, studies in cognitive science and organizational psychology have shown that employees'cognitive load directly impacts their ability to complete tasks effectively. High cognitive load or stress can lead to errors, slower task completion, and reduced overall efficiency. Conversely, tasks assigned during periods of low cognitive load may not fully utilize an employee's capabilities, leading to suboptimal productivity.

The need for a dynamic, responsive approach to workflow management is evident. By leveraging real-time neurophysiological data from wearables, enterprises can gain actionable insights into employees'cognitive states and use this data to make intelligent, adaptive workflow decisions. Such a system would optimize task assignments based on an employee's current physiological and cognitive state, historical performance trends, and the complexity of the tasks at hand. This approach would not only enhance productivity but also promote employee well-being by balancing workloads and reducing stress.

The present invention addresses these challenges by introducing an integrated system for adaptive workflow orchestration. It combines real-time biometric data collection from wearables with advanced data processing and machine learning algorithms to assess cognitive load and predict task performance potential. Using this information, the system dynamically updates task queues in enterprise resource planning (ERP) systems and ticket management platforms to ensure optimal task routing.

This invention represents a significant advancement in the field of enterprise workflow optimization by bridging the gap between wearable technology and task management systems. By incorporating real-time physiological data into task assignment processes, it provides a novel approach to improving productivity, employee well-being, and resource utilization in enterprise environments.

### SUMMARY OF THE INVENTION

The present invention provides a novel system and method for optimizing enterprise workflows by utilizing real-time neurophysiological data collected from wearable devices. The invention addresses the limitations of traditional static workflow management systems by dynamically adjusting task assignments based on employees'cognitive and physiological states. This approach aims to enhance productivity, improve resource allocation, and promote employee well-being in enterprise environments.

The system integrates wearable devices such as smartwatches, fitness trackers, and other biometric sensors which collect real-time data, including heart rate variability, stress levels, neural activity (EEG), physical activity, and movement. A secure data collection layer ensures reliable transmission of biometric data to the processing engine while maintaining privacy.

A neural processing engine processes raw sensor data using advanced algorithms for signal filtering, pattern recognition, and feature identification to calculate cognitive load metrics, stress levels, and performance potential based on neurophysiological data. This information is used to generate real-time assessments of employees mental and physical states.

The invention includes a workflow optimization engine that dynamically adjusts task assignments. It analyzes cognitive load metrics in conjunction with historical task performance data to determine the optimal assignment for each task. Task attributes such as complexity, priority, and dependencies are factored into the decision-making process.

In an embodiment of the present invention, the system integrates with existing enterprise resource planning (ERP) systems, ticketing platforms, and other task management tools via APIs. Real-time updates are pushed to task queues, ensuring that assignments are always aligned with employees'current states and enterprise priorities.

The system employs end-to-end encryption, anonymous data processing, and access controls to safeguard sensitive employee data. Compliance with data privacy regulations ensures ethical handling of neurophysiological information.

The invention enables optimized workforce management by dynamically assigning tasks based on employee cognitive states thus balancing workloads across teams, ensuring efficient resource utilization. The system routes calls or tickets to employees best suited to handle them at a given time, considering stress levels and past performance. By adjusting workflows to minimize excessive stress and cognitive load, the invention helps improve overall employee health and job satisfaction. In industries such as healthcare, IT support, and finance, the invention ensures that critical tasks are assigned to employees in optimal mental states.

In summary, the present invention introduces a groundbreaking approach to enterprise workflow management by combining wearable technology, advanced data analytics, and task optimization. It leverages real-time insights into employee states to drive intelligent decision-making, ensuring a productive, efficient, and healthy workplace.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE ACCOMPANYING DRAWINGS

The aforesaid as well as other objects and advantages of the invention will appear hereinafter from the following description taken in connection with the accompanying drawings in which:

FIGS. 1A, 1B, 1C, and 1D illustrates an exemplary block diagram of system architecture in accordance with an embodiment of the present invention;

FIGS. 2A, 2B, and 2C illustrates exemplary workflow diagram in accordance with an embodiment of the present invention;

FIG. 3 illustrates sequence diagram in accordance with an embodiment of the present invention;

### DETAILED DESCRIPTION OF THE INVENTION

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

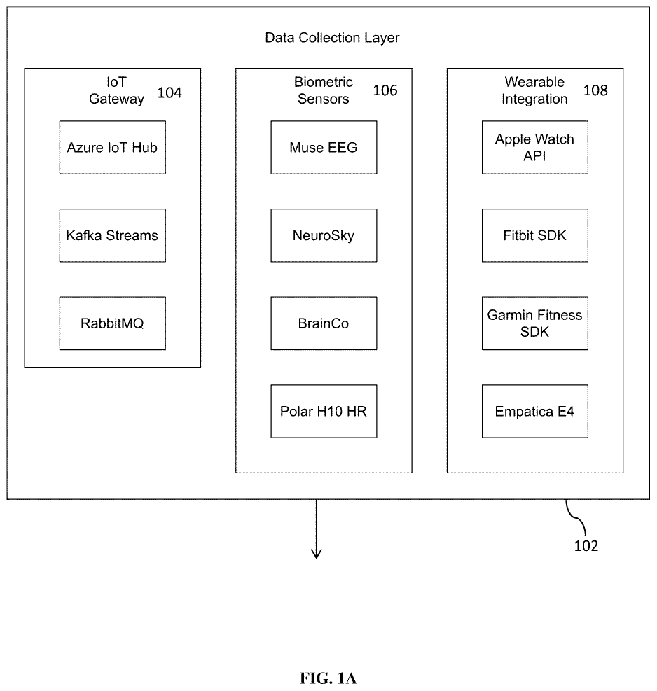

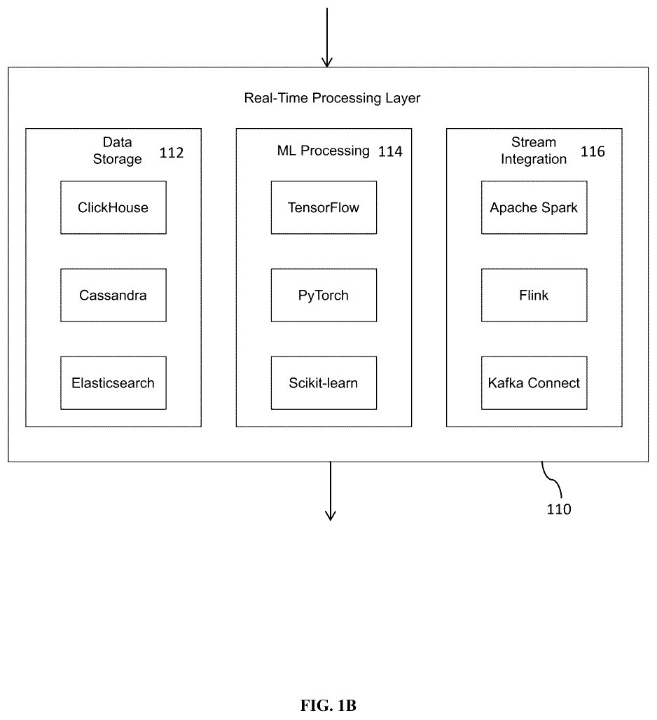

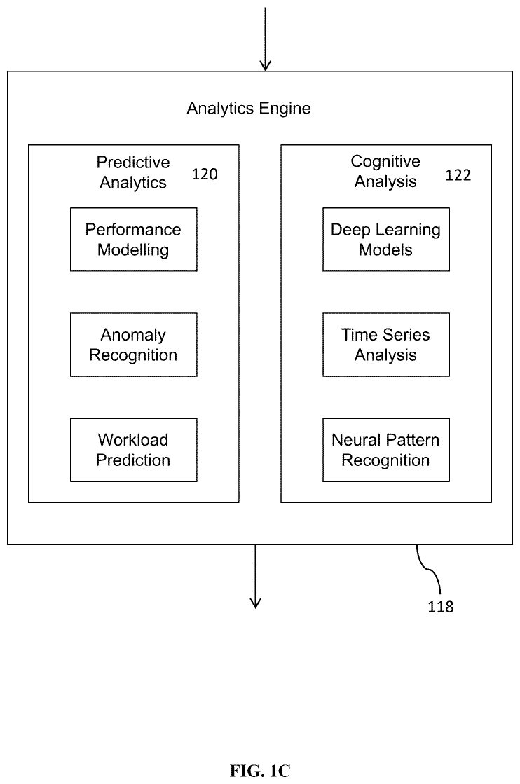

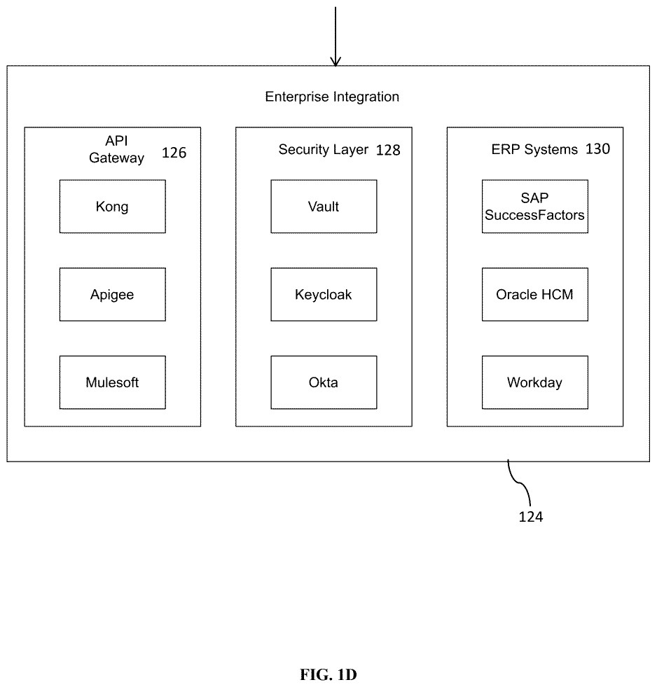

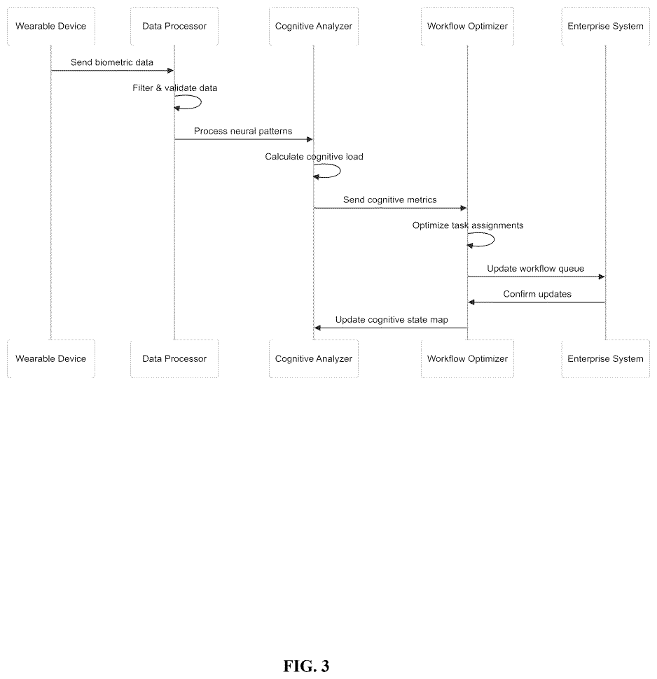

With reference now to the drawings, and in particular to FIG. 1A and FIG. 3 thereof, a system and method for adaptive workflow orchestration using neurophysiological data in enterprise resource planning system embodying the principles and concepts of the present invention is described.

The present invention introduces a comprehensive system and method for adaptive workflow optimization that leverages real-time neurophysiological data collected through wearable devices. This system addresses the inefficiencies of traditional task management by dynamically assigning tasks based on an employee's cognitive state, stress levels, and historical performance. The invention integrates wearable technology, data processing, machine learning, and enterprise systems to create a responsive and efficient workflow management system.

FIG. 1A to FIG. 1D illustrates system architecture of the present invention wherein the data processing layer 102 is the foundational component of the invention, where raw biometric and environmental data is gathered and transmitted for further analysis. This layer ensures seamless, secure, and accurate communication between wearable devices and the central processing system. The IoT Gateway 104 acts as a bridge between wearable devices and the real-time processing system. Its primary role is to manage communication, streamline data transfer, and ensure data reliability. The device communication management connects multiple wearable devices and biometric sensors to the system infrastructure ensuring data packets are transmitted without loss, even in cases of intermittent connectivity. It also converts device-specific communication protocols into standardized formats for uniform data processing. The data is temporarily stored for seamless streaming into processing pipelines ensuring consistency even during high-volume data surges.

The biometric sensors 106 are specialized devices that collect raw physiological and neurological data from users. These sensors provide a detailed view of an individual's cognitive state, stress levels, and physical activity. Sensors like Muse EEG, Neurosky, BrainCo measure neural activity to assess cognitive load, mental focus, and fatigue levels providing insights into brainwave patterns (e.g., alpha, beta, and theta waves). The Polar H10 HR sensor monitors heart rate variability (HRV), which serves as a proxy for stress and recovery states. It also tracks real-time heart rate for physical readiness evaluation.

In an embodiment of the present invention, the wearable integration modules 108 like APIs and SDKs ensures commercial wearable devices like smartwatches and fitness trackers are seamlessly connected to the system. The APIs and SDKs provide access to device sensors for collecting biometric data such as heart rate, activity, and stress metrics enabling real-time streaming of data to the IoT Gateway.

The Real-Time Processing Layer 110 processes raw data collected from the Data Processing Layer, transforming it into meaningful insights in near real-time. This layer ensures the system can analyze, process, and respond to biometric and environmental data to optimize task assignments dynamically.

The Data Storage component 112 is responsible for storing both raw and processed data, enabling efficient querying and retrieval for further analysis. The unprocessed data is directly collected from IoT devices, wearable sensors, and APIs ensuring historical data is available for long-term analysis and trend prediction. The intermediate results from stream processing and ML pipelines, such as derived stress levels or cognitive load metrics are also stored the data storage enabling real-time retrieval for analytics and decision making.

The ML Processing component 114 applies machine learning models to analyze and interpret the incoming data streams. It is central to the system's ability to predict, recognize, and adapt based on user states. The raw biometric data is processed into meaningful features (e.g., heart rate variability, EEG wave classifications) using supervised and unsupervised learning techniques. The machine learning models are utilized to predict user performance, workload, and cognitive states providing real-time insights for task optimization based on historical and current data.

The Stream Processing component 116 processes data in real-time as it flows into the system. It ensures the system responds to changes in user states dynamically, enabling near-instantaneous decision-making. The continuous streams of data captured from the IoT Gateway and wearable devices is prepared for real-time analysis by cleaning and normalizing it. Specific events or patterns (e.g., stress surges, cognitive fatigue) are detected as they occur sending real-time alerts or triggering workflow adjustments based on data insights.

The Analytics Engine 118 is the central intelligence of the invention, designed to analyze processed data and derive actionable insights that optimize task assignment and workflow efficiency. The Predictive Analytics 120 component focuses on leveraging historical and real-time data to anticipate outcomes. Using advanced machine learning and statistical modeling techniques, it predicts workload trends, user performance, and resource utilization patterns. For example, it can determine whether a user is likely to excel or struggle with a specific type of task based on their biometric signals, past performance, and workload history. This includes anomaly detection, which identifies irregular patterns such as stress spikes or significant cognitive fatigue, and workload prediction, which estimates the user's capacity to handle additional tasks at a given moment. By forecasting these metrics, the system ensures that tasks are assigned to the most suitable personnel, avoiding overburdening and maximizing efficiency.

The Cognitive Analysis 122 component dives deeper into understanding the user's mental and emotional state. By applying advanced deep learning models, it interprets cognitive and neural patterns derived from EEG signals, heart rate variability, and other biometric data. This enables the system to assess states such as focus, fatigue, and stress levels with high precision. For instance, through time-series analysis, the system tracks how a user's cognitive load evolves over a shift or task. Neural pattern recognition further enhances this understanding by identifying recurring behavioral patterns, such as when a user is at peak performance versus moments of cognitive decline. These insights are critical for dynamically adjusting workflows, such as delaying non-urgent tasks during periods of high fatigue or assigning tasks that match the user's current cognitive state.

Together, the Predictive Analytics and Cognitive Analysis components form a feedback loop, continuously refining the system's understanding of user behavior. While Predictive Analytics ensures proactive decision-making by forecasting future states, Cognitive Analysis provides an in-depth understanding of current user conditions. The integration of these components allows the Analytics Engine to provide real-time, context-aware insights that improve overall system efficiency, user well-being, and task outcomes. By combining these capabilities, the Analytics Engine serves as the decision-making powerhouse that enables a truly adaptive, responsive workflow system.

The Enterprise Integration layer 124 is a critical component of the invention, enabling seamless interaction between the system's internal analytics capabilities and external enterprise platforms. This layer ensures that the insights derived from wearable data are effectively integrated into existing organizational workflows, tools, and processes while maintaining robust security protocols. It is composed of three main sub-components: the API Gateway, Security Layer, and ERP Systems, which together enable efficient communication, secure data handling, and enterprise-wide implementation.

The API Gateway 126 acts as the communication bridge between the Analytics Engine and enterprise applications, providing a standardized interface for external systems to access the processed data and insights. Platforms like Kong, Apigee, and Mulesoft are utilized to expose APIs that allow seamless integration with customer relationship management (CRM), helpdesk, and task management systems. These gateways enable bidirectional data flow, allowing enterprise systems to push relevant metadata (e.g., ticket types or urgency levels) into the analytics pipeline and receive optimized task assignments in real time. The API Gateway also handles essential services such as request routing, rate limiting, and API monitoring to ensure performance and scalability.

The Security Layer 128 provides robust protection for sensitive biometric, behavioral, and enterprise data. Tools like Vault, Keycloak, and Okta are employed to manage identity, authentication, and access control across the system. This ensures that only authorized personnel and systems can interact with the APIs and access the data, protecting against unauthorized use or breaches. Encryption protocols safeguard data at rest and in transit, while tools like token-based authentication and single sign-on (SSO) streamline secure access for users. The security layer is critical for ensuring compliance with regulatory standards such as GDPR or HIPAA when handling sensitive health-related data.

Finally, the ERP Systems 130 integration ensures that the system's insights are effectively embedded into enterprise-level tools like SAP SuccessFactors, Oracle HCM, and Workday. These ERP platforms are essential for managing workflows, resource allocation, and employee productivity. By integrating with ERP systems, the invention ensures that task assignments, workload adjustments, and performance metrics are directly reflected in the organization's central management systems. For instance, a workload prediction model can trigger a task reassignment directly within SAP SuccessFactors, or stress-related insights can inform workforce planning in Workday. This deep integration enables organizations to operationalize the insights generated by the system, bridging the gap between data analysis and practical execution.

Together, the API Gateway, Security Layer, and ERP Systems ensure that the invention is not just a standalone analytics platform but a fully integrated enterprise solution. They enable the system to operate within existing organizational infrastructures, ensuring seamless adoption, robust data security, and impactful, actionable insights that drive operational efficiency.

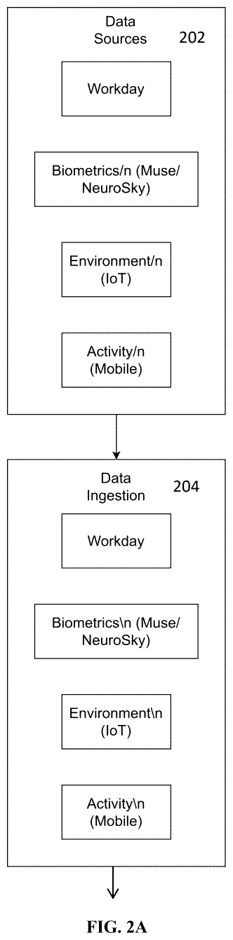

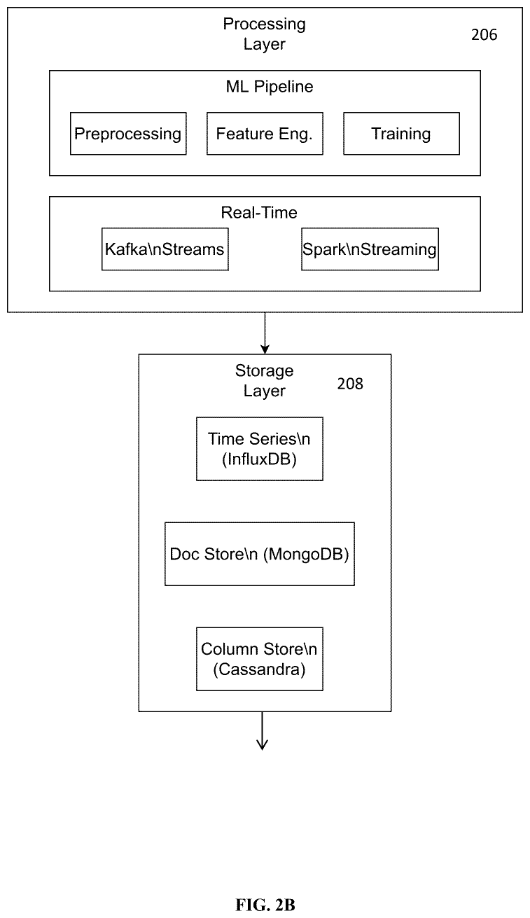

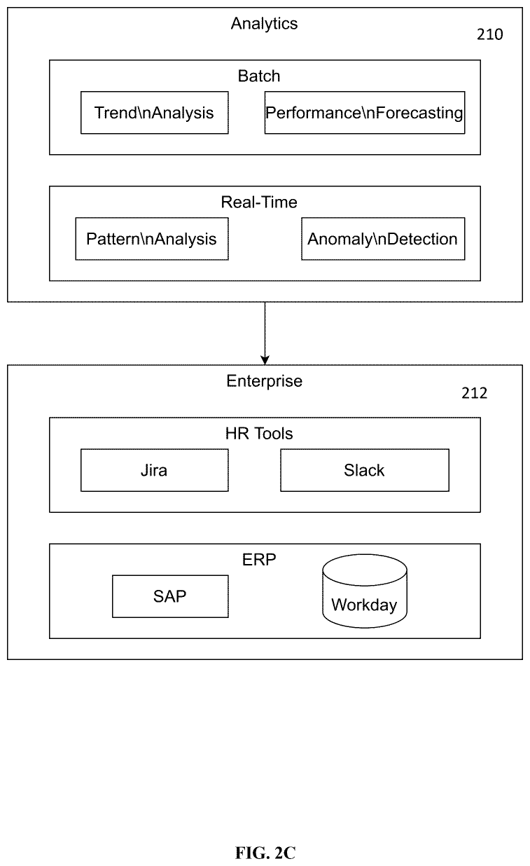

The diagram in FIG. 2A to FIG. 2C illustrates the comprehensive workflow of the invention, which integrates real-time data from various sources, processes it through sophisticated layers, and delivers actionable insights for enterprise task optimization. The process begins with the data sources layer 202, which encompasses a wide array of inputs: biometric data collected from devices like Muse or NeuroSky, environmental data captured through IoT sensors, activity data gathered from mobile applications, and organizational data from platforms like Workday. These diverse data streams form the foundation of the system by providing critical insights into user behavior, environmental factors, and organizational trends.

The data flows into the data ingestion layer 204, which ensures seamless collection, aggregation, and integration of incoming information. Technologies like Kafka and Spark facilitate high-throughput, low-latency data streaming, while tools like NiFi and Fluentd manage the orchestration and flow of structured and unstructured data. This layer ensures that raw data is efficiently captured and prepared for further processing without loss or bottlenecks.

Once ingested, the data moves into the processing layer 206, where the system applies machine learning (ML) pipelines for preprocessing, feature engineering, and training of predictive models. The preprocessing step cleanses and standardizes the data to ensure uniformity and compatibility. Feature engineering extracts relevant attributes, such as patterns in biometric signals or anomalies in activity levels, which are critical for downstream analysis. The training phase uses this refined data to develop robust models capable of recognizing complex patterns and predicting outcomes. Simultaneously, real-time components of this layer, such as Kafka Streams and Spark Streaming, process live data to provide immediate insights into the ongoing conditions, enabling the system to react dynamically.

Processed data is then stored in the storage layer 208, which uses specialized databases optimized for different data types. Time-series databases like InfluxDB store continuous streams of biometric data, while document stores like MongoDB handle unstructured data, such as logs or reports. Columnar databases like Cassandra store high-volume structured data, enabling quick retrieval and analysis. This layered storage architecture ensures scalability and efficient access to data for various analytical purposes.

The analytics layer 210 utilizes this data to generate both batch and real-time insights. Batch analytics encompasses trend analysis to identify long-term patterns, performance forecasting to predict future outcomes, and pattern analysis to recognize recurring behaviors or anomalies. Real-time analytics enables anomaly detection and immediate responses to deviations from expected behavior, ensuring rapid adjustments to task assignments and workflows.

Finally, the system interfaces with the enterprise layer 212, where insights are translated into actionable tasks and integrated into organizational tools. HR tools like Jira and Slack facilitate seamless communication and task assignment, while ERP systems like SAP and Workday ensure alignment with enterprise workflows and resource planning. This integration ensures that optimized task assignments are effectively implemented in real-world scenarios, bridging the gap between advanced analytics and operational efficiency.

In summary, the invention works as a holistic system, starting from data collection to final enterprise integration. It leverages real-time and batch processing, advanced machine learning, and seamless enterprise integration to create a dynamic, adaptive task management solution that enhances both employee well-being and organizational productivity.

Reference is now made to FIG. 3, illustrating the flow of data and interactions between the key components of the invention. The process begins with the Wearable Device sending biometric data, such as heart rate, EEG signals, and other physiological parameters, to the Data Processor. These wearables, like smartwatches or biometric sensors, continuously monitor the user's physical and cognitive states and relay this data for analysis. Upon receiving the raw biometric data, the Data Processor filters and validates the data to ensure its accuracy and reliability. This step involves removing noise, handling missing data, and ensuring that the data is in a usable format. Reliable and high-quality data is crucial for downstream analysis. The filtered and validated data is then passed to the Cognitive Analyzer, which processes neural patterns and other cognitive indicators. This component uses advanced algorithms, such as machine learning and neural network models, to interpret cognitive metrics such as focus, stress levels, and cognitive load. The Cognitive Analyzer calculates the user's cognitive load based on the processed data. Cognitive load reflects the mental effort required to perform tasks and provides insights into the user's ability to handle additional work or whether they are in a state of fatigue or high stress. Once the cognitive metrics are computed, they are sent to the Workflow Optimizer. This information serves as the basis for optimizing task assignments and workload distribution. The Workflow Optimizer uses the cognitive metrics to analyze the user's current state and compare it with historical performance and workload trends. Based on this analysis, it determines the most suitable tasks for the user and optimizes the task assignment process. For example, users under high cognitive load might be assigned simpler tasks, while those in peak cognitive states might receive more complex tasks. The optimized task assignments are updated in the workflow queue of the Enterprise System. This ensures that tasks are aligned with the real-time cognitive state of the user, leading to more efficient task handling and improved productivity. The Enterprise System confirms the updates to the workflow queue, signaling that the task assignments have been successfully implemented. This feedback loop ensures synchronization between the optimizer and enterprise operations. The Workflow Optimizer updates its cognitive state map with the new metrics and insights from the optimization process. This map tracks user states over time, enabling the system to refine predictions and improve future task assignments dynamically. This sequence ensures a seamless flow of data and decisions, leveraging real-time biometric inputs to adaptively optimize workflows. It highlights the invention's ability to integrate wearable technology, cognitive analytics, and enterprise systems to create a responsive and intelligent task management solution.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclosed herein suitably may be practiced in the absence of any element which is not specifically disclosed herein—and in particular embodiment specifically contemplated, is intended to be practiced in the absence of any element which is not specifically disclosed herein.

1. A system for optimizing task assignments in an enterprise environment based on real-time biometric data, the system comprising:
a wearable device configured to collect biometric data from a user, including one or more of heart rate, EEG signals, and cognitive metrics;
a data processor configured to receive the biometric data from the wearable device, filter and validate the data, and transmit the data for further analysis;
a cognitive analyzer configured to process the validated data, calculate a cognitive load metric based on the data, and transmit cognitive metrics to a workflow optimizer;
a workflow optimizer configured to optimize task assignments based on the cognitive metrics received from the cognitive analyzer, adjust workload distribution, and update a workflow queue in an enterprise system.

2. The system of claim 1, wherein the data processor is further configured to handle missing data, remove noise from the raw biometric data, and ensure data accuracy before transmission.

3. The system of claim 1, wherein the cognitive analyzer utilizes machine learning or neural network models to process neural patterns and compute cognitive metrics, including mental fatigue, stress levels, and focus.

4. The system of claim 1, wherein the cognitive load metric is calculated by assessing one or more factors selected from the group consisting of heart rate variability, EEG activity, mental stress, and engagement levels.

5. The system of claim 1, wherein the workflow optimizer is configured to compare the cognitive metrics to historical performance data and workload trends to determine the most suitable task assignments for a user.

6. The system of claim 1, wherein the workflow optimizer automatically assigns simpler tasks to a user with high cognitive load and more complex tasks to a user with lower cognitive load, thereby optimizing productivity.

7. The system of claim 1, wherein the workflow optimizer sends the optimized task assignments to an enterprise system, wherein the enterprise system updates a workflow queue and confirms the updates.

8. The system of claim 1, wherein the enterprise system includes one or more enterprise
resource planning (ERP) systems selected from the group consisting of SAP SuccessFactors, Oracle HCM, and Workday, and is configured to integrate with the workflow queue to synchronize task assignments across the enterprise.

9. A method for optimizing task assignments in an enterprise system using real-time biometric data, the method comprising the steps of:
collecting biometric data from a user through a wearable device, including one or more of heart rate, EEG signals, and cognitive metrics;
filtering and validating the biometric data using a data processor;
calculating cognitive load based on the processed biometric data using a cognitive analyzer;
sending cognitive metrics from the cognitive analyzer to a workflow optimizer;
optimizing task assignments based on the cognitive metrics, adjusting workload distribution, and updating a workflow queue in an enterprise system.

10. The method of claim 9, wherein the cognitive metrics used to optimize task assignments include one or more of cognitive load, stress levels, and focus, derived from the biometric data collected by the wearable device.

11. The method of claim 9, wherein the step of optimizing task assignments further comprises comparing the cognitive metrics with historical performance data to identify the most suitable tasks for the user.

12. The method of claim 9, wherein the enterprise system includes an ERP system, and the optimized task assignments are integrated into the ERP system to synchronize task distribution across the enterprise.

13. The method of claim 10, further comprising the step of updating the cognitive state map based on the calculated cognitive metrics, allowing the system to refine future task assignments.

14. A non-transitory computer-readable medium having stored thereon instructions that, when executed by a processor, cause the processor to perform the method of claim 9.

15. The system of claim 1, wherein the cognitive analyzer includes a neural network model that processes EEG signals and generates a real-time cognitive load prediction.

16. The system of claim 1, wherein the data processor is further configured to transmit the validated biometric data to an API gateway that facilitates communication between the wearable device and the enterprise system.
